(19) United States
(12) Patent Application Publication
(10) Pub. No.: US 2004/0220866 A1
(43) Pub. Date: Nov. 4, 2004

(54) Investment grade collateralized variable rate demand notes and computer-based reporting related thereto

(76) Inventor: Joanne Marlowe-Noren, Wadsworth, IL (US)

Correspondence Address: Paul E Schaafsma, Unit 221, 521 West Superior, Chicago, IL, 60610, US

(21) Appl. No.: 10/860,743

(22) Filed: Jun. 3, 2004

Related U.S. Application Data
(63) Continuation-in-part of application No. 10/400,211, filed on Mar. 27, 2003.

(51) Int. Cl. G06F 17/60

(52) U.S. Cl. 705/35

(57) ABSTRACT

A computer implemented financial instrument and method of financing is disclosed that includes offering a financial instrument for the purpose of attracting investment; placing the proceeds from the financial instrument on deposit in a reserve account in such manner so as to ensure the bankruptcy remote status of such proceeds from an entity administering the operation of the proceeds of the financial instrument; subsequently issuing an equal value letter of credit to secure the payment of a principal portion of the financial instrument; issuing a second letter of credit to secure interest due on the financial instruments; subsequently managing and implementing the proceeds of the sale of the financial instrument in a manner consistent with a generic investment criteria established related to that certain offering. A wide area network implementation of the reporting methodology for investment, performance, and user data pertaining to the financial instrument of the present invention is further described.

### RELATED APPLICATION

This application is a continuation-in-part of U.S. patent application Ser. No. 10/400,211 titled “INVESTMENT GRADE COLLATERALIZED VARIABLE RATE DEMAND NOTES” filed on 27 Mar. 2003.

### FIELD OF THE INVENTION

The present invention relates to demand notes and similar financial products and the computer-based reporting infrastructure related thereto.

### BACKGROUND OF THE INVENTION

The use of Variable Rate Demand Notes (VRDNs) as a tool for raising debt in the capital markets for the benefit of corporate and municipal entities has been popularized during recent years. VRDNs provide an ability to marry long-term debt and finance commitments with a short-term interest rate. Use of VRDNs has been further enhanced by certain regulatory dictates that create a beneficial environment for the sale and placement of financial products having characteristics consistent with traditional VRDNs.

The maturation of VRDNs as a generally accepted financial product has brought benefits to the financial market. Commercial banks may continue to originate and underwrite commercial, municipal or other debt-based projects without being saddled with substantial reserve requirements, the booking of cash loans or being otherwise restricted due to the size of a loan or a project being underwritten. These developments in the VRDN market have served to evidence how VRDNs, as a hybrid security having characteristics of both bond issues and traditional bank loans, have a commercial advantage over previously available corporate debt securities. VRDNs demonstrate how traditional term loan underwriting procedures that have been undertaken by banking institutions and underwriters may be utilized in an innovative manner to create and enhance a financial instrument that can be sold widely into the capital marketplace via private placement and remarketing agreements.

VRDNs can be sold or placed with money market funds, investment funds and virtually any other institution that has an interest in obtaining investment grade financial instruments meeting certain investment criteria to which VRDN's subscribe. The sale or placement of VRDNs is the foundation upon which traditional bank underwriting procedures may be openly coordinated with the institutional capital markets in order to access a pool of additional capital that otherwise would not have been accessible. This in turn brings additional capital to the likes of the typical project that would be underwritten and sold via a VRDN issuance.

Specifically, in today's United States-based institutional capital markets, institutional investors purchase financial products in substantial “blocks”, looking toward the credit rating of the instrument being acquired and the yield thereon as the two criteria upon which a determination to make an investment is afforded. An institutional investor is not inclined to undertake an underwriting process to determine the credit-worthiness of an investment opportunity. In addition, such an investment methodology would be both impractical and cost and time-prohibitive to investors in the capital markets. Instead, the institutional capital markets rely on investment bankers and underwriters to prepare, consolidate, package and arrange for the rating of proposed investments prior to the investor's review and consideration of such for inclusion in its portfolio.

Through the use of VRDNs in their prior art incarnation, investment grade commercial banks are able to: (i) identify projects or borrowers which they believe to be respectively credit worthy in their own right; (ii) apply standard underwriting methodologies of the commercial bank to review, evaluate and package each such subject project or borrower; (iii) approve such project for credit; (iv) provide credit to the subject project or borrower in the form of a specifically formatted letter(s) of credit (which takes advantage of certain regulatory guidelines relative to bank reserve requirements related to granting credit) rather than in the form of a credit line or loan; (v) attach its letter of credit to the issuance of a specific VRDN series for the benefit of the underwritten project or company such that the letter of credit enhances the credit worthiness of the VRDNs being issued, normally causing the customary credit rating of the debt obligations of the underwriting institution to be passed through to the VRDN's themselves; and (vi) facilitate or otherwise aid in the sale, placement and remarketing of the VRDN series with institutional capital markets investors from whom the actual debt proceeds will ultimately be raised and made available to the duly underwritten subject client or project of the commercial bank.

Ultimately, by utilizing VRDNs as the basis to raise the debt capital for a bank underwritten project, all parties to the VRDN transaction benefit. For instance, the borrower may be seeking finance that exceeds traditional lending limits or is otherwise unsuitable for underwriting on a cash loan or credit line basis. Alternatively, the borrower may simply but definitively benefit from advantages associated with short term adjustable interest rates as applied to a properly commercially underwritten VRDN. The use of VRDNs affords the borrower the opportunity to take advantage of short-term interest rates while, via a remarketing agreement with a suitable securities remarketing agent for the duration of a VRDN term, obtaining a long-term financing commitment as facilitated by the commercial bank/underwriter.

The commercial bank that is underwriting the project or borrower also benefits. The commercial bank makes certain fee income related to the underwriting of the project, for example, it likely issues the letter of credit, may place the VRDNs in the institutional capital markets and, in some cases, may also remarket the VRDNs throughout the note term. The most consequential benefit to the underwriter, however, is the ability to grant credit to the borrower in the form of a letter of credit. When the letter of credit is formatted in a certain manner, the bank is then able to grant credit with specific benefits and advantages in complying with certain lending reserve requirements as defined by regulatory guidelines, thus increasing the total potential amount of commercial lending business that the bank may conduct.

Finally, the institutional capital market investor benefits from the acquisition of the VRDNs by having available to it certain highly rated short-term investments which by regulatory guidelines it must maintain with respect to its portfolio. Specifically, the typical VRDN investors are money market funds, and to a lesser extent, corporations, trust departments and high net worth individuals. Of these, money market funds are generally required under the Securities and Exchange Commission Investment Company Act to invest in high quality short term obligations bearing interest at a rate calculated to give obligations purchased a market value of par. The hybrid nature of a VRDN makes this instrument attractive to fill this market need since the credit quality of the commercial bank/underwriter that issued the letter of credit that supports the payments due under the VRDNs is customarily of high quality and readily acceptable to the subject buyers.

In light of the foregoing, there is no doubt a benefit to the advent and development of the VRDN instruments in the debt markets in their prior art incarnation. However, prior art VRDNs contain several limitations that limit their use to funding projects that are (i) candidates for traditional term loan underwriting by a conventional commercial bank, (ii) specifically pre-identified, and (iii) usually financed via a single VRDN series issuance and enhanced via a single underwriter.

Specifically, the type of subject matter investment that is or can be converted to a VRDN placement generally exhibits the same credit worthiness as any other project which may be candidate for traditional term loan underwriting by a conventional commercial bank. Such a baseline credit criteria restricts the use of VRDNs in support of more speculative/higher return projects, non-speculative but transaction-based projects or other projects which may lack traditional collateral structures or historically definable revenue typically deemed acceptable to commercial banks in their standard underwriting models. By nature, these credit limitations make prior art VRDNs generally impractical for use by alternative capital companies, venture firms or investment banking houses which deem the risks and returns associated with projects of the foregoing descriptive categories acceptable and any other projects which fall outside the market-favored operations area or industries at the time of VRDN issuance and placement.

Second, under current circumstances in which VRDNs are sometimes issued, the underlying project must be identified with specificity before the underwriting process may begin. This is a reasonable predicate to underwriting a project through traditional commercial means, but eliminates the possibility of utilizing VRDNs as a means to raise debt capital by a fund or investment manager in support of an investment pool or fund operating profile in which general investment criteria for subsequent investment are consistent with policy of the underwriter, but are not identified with particularity prior to the date of sale of the VRDNs.

Third, the prior art VRDN structure does not easily accommodate the process of conducting multiple issuances for the same project over a given period of time with a view to raising and accumulating a substantial amount of debt capital for projects which may require multiple or syndicated underwriters for the purposes of credit enhancing the VRDNs prior to sale into the capital market. For example, prior art VRDN structures make a phased syndication of underwriter participation difficult on a large scale such as in the process of raising funds that may be required for a substantial singular acquisition. In such case, the substantial singular acquisition that would customarily require participation of more than one lender in a conventional lender environment cannot be accommodated and coordinated easily via a VRDN issuance. Thus, there still remains substantial room for improvement on this type of financial product.

What is thus needed is a new financial instrument that can be applied to a broader range of projects than that which is acceptable under a traditional commercial bank underwriting criteria. Such financial instrument preferably can be applied to raise relatively inexpensive debt capital in support of the creation, establishment, growth or development of an investment or venture capital fund without specific projects having been identified in detail prior to instrument issuance, rating and placement. Such financial instrument preferably can be utilized in raising substantial, yet relatively inexpensive, sums of debt capital in support of large scale projects and developments. Such new financial instrument would promote a greater availability of institutional debt in the capital markets for projects that otherwise would not customarily be substantial enough to garner such cost-effective finance. Lastly, such new financial instrument would foster the more efficient and cost effective issuances of instruments into the institutional capital markets by way of higher aggregate note series values and larger volumes, thus promoting more substantial issues by single issuers or debt-based investment funds.

### SUMMARY OF THE INVENTION

A financial instrument in accordance with the principles of the present invention can be applied to a broader range of projects than that which is acceptable under a traditional commercial bank underwriting criteria. A financial instrument in accordance with the principles of the present invention can be applied to raise relatively inexpensive debt capital in support of the creation, establishment, growth or development of an investment or venture capital fund without specific projects having been identified in detail prior to instrument issuance, rating and placement. A financial instrument in accordance with the principles of the present invention can be utilized in raising substantial, yet relatively inexpensive, sums of debt capital in support of large-scale projects and developments. A financial instrument in accordance with the principles of the present invention promotes a greater availability of institutional debt in the capital markets for projects that otherwise would not be customarily substantial enough to garner such cost-effective finance. A financial instrument in accordance with the principles of the present invention fosters the more efficient and cost effective issuance of instruments into the institutional capital markets by way of higher aggregate note series values and larger volumes, thus promoting more substantial issues by single issuers or debt-based investment funds. A financial instrument in accordance with the principles of the present invention fosters the development of a potentially diverse network of underwriters and underwriting methodologies for a single issuer or investment fund which potentially aids in defraying collective underwriter risks associated with the operation of the single issuer, investment or venture capital fund.

A financial instrument in accordance with the principles of the present invention can be sold or placed prior to the identification of particular beneficial projects. A financial instrument in accordance with the principles of the present invention permits the individual project underwriting to effectively occur after-the-fact, once the proceeds arising from the placement are held for the benefit of the issuer of the financial instruments. Thus, a financial instrument in accordance with the principles of the present invention creates an environment that is conducive to the utilization of this instrument for raising relatively inexpensive capital in support of privately managed investment or venture capital funds. A financial instrument in accordance with the principles of the present invention can broaden or otherwise ease the credit underwriting criteria and underlying collateral structures which are the basis for the issuance of a respective letter of credit that is ultimately utilized as credit enhancement to and security for the financial instrument by way of fostering the creation of underwriting syndications, hybrid or specialized reserve funds agreements and underlying insurance guarantees, all of which contribute to more meaningful and aggressive risk management and distribution by the underwriter(s).

A financial instrument in accordance with the principles of the present invention allows the issuer to raise substantial amounts of low-cost financing against the placement or sale of the financial instruments over a period of time via the issuance of multiple note series as may be incrementally underwritten by a variety of letter of credit underwriters taken together in support of a substantially valued project. Thus, a financial instrument in accordance with the principles of the present invention fosters the more efficient and cost effective issuance and sale of financial instruments to the institutional capital markets by way of facilitating higher values and larger volumes of note series.

A financial instrument in accordance with the principles of the present invention utilizes a hybrid, phased collateral structure consisting first of a cash-secured financial instrument which is subsequently convertible to a letter of credit secured financial instrument, such that the aggregate total face value of financial instruments in either the convertible form, the converted form or any interim combination of the two is fully secured by highly rated collateral, thus taking full advantage of the well established market operations associated with the sale and placement of prior art VRDNs

### BRIEF DESCRIPTION OF THE DRAWINGS

FIG. 1 is a schematic overview of a preferred embodiment of a wide area network implementation of the monitoring and reporting of user implementation of a financial instrument in accordance with the principles of the present invention.

FIG. 2 is a schematic overview of a preferred embodiment of a wide area network implementation of the monitoring and reporting of investment performance related to a financial instrument in accordance with the principles of the present invention.

FIG. 3 is a methodological schematic overview of a subscription through retirement process in accordance with the principles of the present invention.

FIG. 4 is a methodological schematic showing details of settlement of a permitted tender of convertible notes during the reserve period in accordance with the principles of the present invention.

FIG. 5 is a methodological schematic showing details of settlement of a permitted tender of the converted notes in accordance with the principles of the present invention.

### DETAILED DESCRIPTION OF THE INVENTION

The financial instrument of the present invention enables the creation of a flexible debt instrument which, as supported by a series of specifically coordinated financial mechanisms, complies with purchasing norms of established segments of the institutional capital markets with respect to debt instruments. The financial instrument of the present invention enables the creation of an investment grade debt instrument which is suitable for purchase by institutional investors that subscribe to investment guidelines set forth under the Investment Company Act under the jurisdiction of the Securities and Exchange Commission. The instrument is ratable by Standard & Poor's Ratings Services, 55 Water Street, New York, N.Y. 10041 (“S&P”), Moody's Investors Service, Inc., 99 Church Street, New York, N.Y. 10007 (“Moody's”) or some other comparable credit rating agency. By employing a financial instrument of the present invention, an issuer is able to operate a project, investment opportunity, investment portfolio or investment fund profile within the scope of generally defined investment criteria. This generic investment criteria is disclosed to the candidate investors at the time of sale or placement of the financial instruments. The generic investment criteria enables the selection and underwriting of certain particular investments which meet the eligibility and credit criteria as established and disclosed by the issuer to occur at the discretion of the issuer even after the sale of the financial instruments in the capital markets.

A financial instrument of the present invention combines the advantages of a traditional, rated, investment grade security such as a VRDN with the advantages of certain trust and reserve mechanisms, producing a circumstance which permits debt capital to be raised in volume for general investment purposes rather than specific project-based applications. The financial instruments of the present invention are uniformly formatted amongst themselves whether in the respective convertible or converted phase such that a standardized debt, security or financial instrument is created which need not materially vary based upon the nature of the underlying collateral or the intended use of proceeds derived from the sale or placement of the financial instrument to the investor.

The financial instruments of the present invention are ratable by a credit rating agency while in the convertible phase based upon the trust and reserve structures employed during the initial reserve period for the financial instrument. Then, upon the provision of an acceptable letter of credit, the financial instruments of the present invention are converted into financial instruments that are ratable, if need be, based upon traditional letter of credit-based credit enhancement mechanisms arising from an application and refinement of certain standard underwriting mechanisms. Thus, the financial instruments of the present invention raise placement efficiencies and create a foundation in the marketplace that is conducive to the volume placement, sale and remarketing of the financial instruments. Particularly, the financial instruments of the present invention assure the suitability and marketability of the short-term nature of the instrument in a manner that meets the short-term investment requirements of the investor (comparable to a prior art VRDN) while also accommodating the long-term debt requirements of the issuer under an operating profile which potentially provides greater flexibility as to use of proceeds by the issuer.

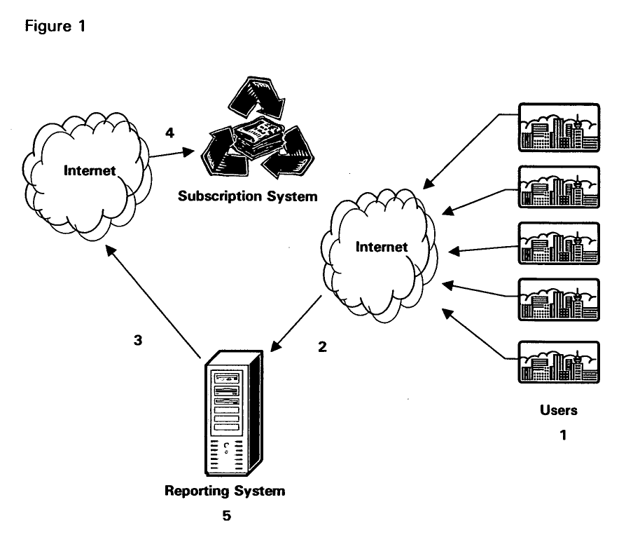

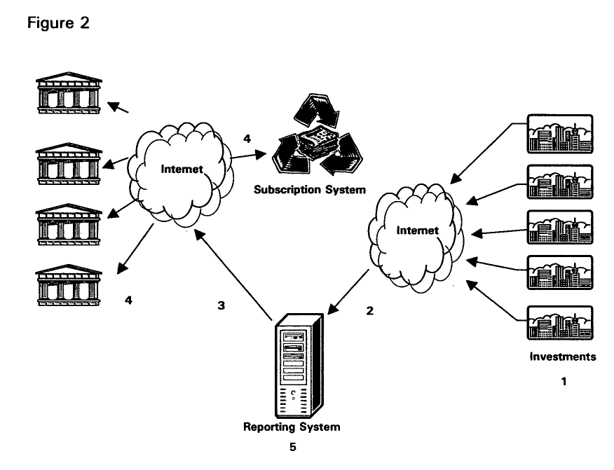

Referring to FIGS. 1 and 2, a preferred embodiment of a wide area network implementation of the process of the financial instrument in accordance with the principles of the present invention is seen. In a preferred embodiment, the wide area network is the Internet. In a preferred embodiment, the system is composed of two major elements: a web browser and a web server. The web browser is platform (e.g. Sparc™, Risc, ×86) independent and operates on any software capable of displaying HyperText Markup Language (HTML) files such as Internet Explorer from Microsoft Corporation of Redmond, Wash. or Netscape Communicator from Netscape Communications Corporation of Mountain View, Calif. The web server may be hosted on a network of Intel-based server systems available from Intel Corporation of Santa Clara, Calif. running on a Microsoft Windows NT Server operating system available from Microsoft Corporation using Enterprise Webserver software from Netscape Communications Corporation. Each of these components may be hosted on separate machines, each of which may be a component of a server farm. Alternative computer systems consisting of one or more computers employing different forms of operating systems and application systems may be used to host the system of the present invention.

Referring to FIG. 1, a schematic overview of a preferred embodiment of a wide area network implementation of the monitoring and reporting of user implementation of the financial instrument in accordance with the principles of the present invention is seen. In a preferred embodiment, this system is contained on a computer system separate from the system that contains the subscription process of the financial instrument of the present invention. Initially, users report certain information, inclusive of financial and organizational data, via a system that will gather and standardize the data for use in monitoring the financial health of the user, the volume of financial instruments issued and deployed into the marketplace, specific issuance and offering detail, the identities of sanctioned financial instrument issuers in affiliation with a given user, and the ratio of convertible to converted financial instruments in the marketplace (1). The monitoring and reporting system receives the information in a standardized web-based form and prepares monthly or quarterly reports, as the case may be, on each respective user's data (2). The user data is passed to the system through a secure web connection in an xml format (3). The user data is used by the subscription system to calculate and track the financial health and performance of each user, track specific issuance activity related to the issuance of the financial instruments, calculate fees due under user agreements, track financial participants' identities (such as Fiscal Agent, Trustee, Placement Agents, etc.) as involved in each issuance, calculate a current tally of financial instruments in the marketplace, identify the ratio of convertible to converted financial instruments such that a collective value of actively deployed funds may be determined, and to determine a market saturation profile of financial instruments then available in the market such that marketing/remarketing cycles can be defined and adjusted (4). Confidential periodic reports are compiled pertaining to the activities of each user in the marketplace as reference materials for the subscriber system (5).

Referring now to FIG. 2, a schematic overview of a preferred embodiment of a wide area network implementation of the monitoring and reporting of investment performance related to the financial instrument in accordance with the principles of the present invention is seen. In a preferred embodiment, this system is contained on a computer system separate from the system that contains the subscription process of the financial instrument of the present invention. Initially, each operating company that has beneficially received an Investment or loan arising from proceeds derived from a sanctioned financial instrument issuance by a user will be required to report certain information to that user, inclusive of financial and organizational data, via a system that will gather and standardize the data for use in monitoring the financial health of the Investment (1). The monitoring and reporting system receives the information in a standardized web-based form and prepares monthly or quarterly reports, as the case may be, for use by the user based upon each respective Investment's data (2). The investment gathering system prepares composite data pertaining to the fiscal performance of the Investment portfolios of each respective user for delivery to the subscription system, and this composite financial data will be delivered via a secure web connection in an xml format. Detailed financial data pertaining to particularized investments' performance is excluded from composite reports and such detailed data is maintained as confidential between user and its respective Investment recipients (3). The Investment/reporting data is used by the subscription system to calculate and track the financial health and performance of each user as such may be deduced from Investment portfolio performance such that overall market performance of investment funds arising from financial instrument offerings and attributable to the present invention can be defined (4). Confidential periodic reports are compiled for reference within the subscription system as the basis to track composite Investment performance of users in the marketplace (5).

### EXAMPLE

For the purposes of explanation and not to narrow the scope of the present invention, the following is an example in accordance with the principles of the present invention.

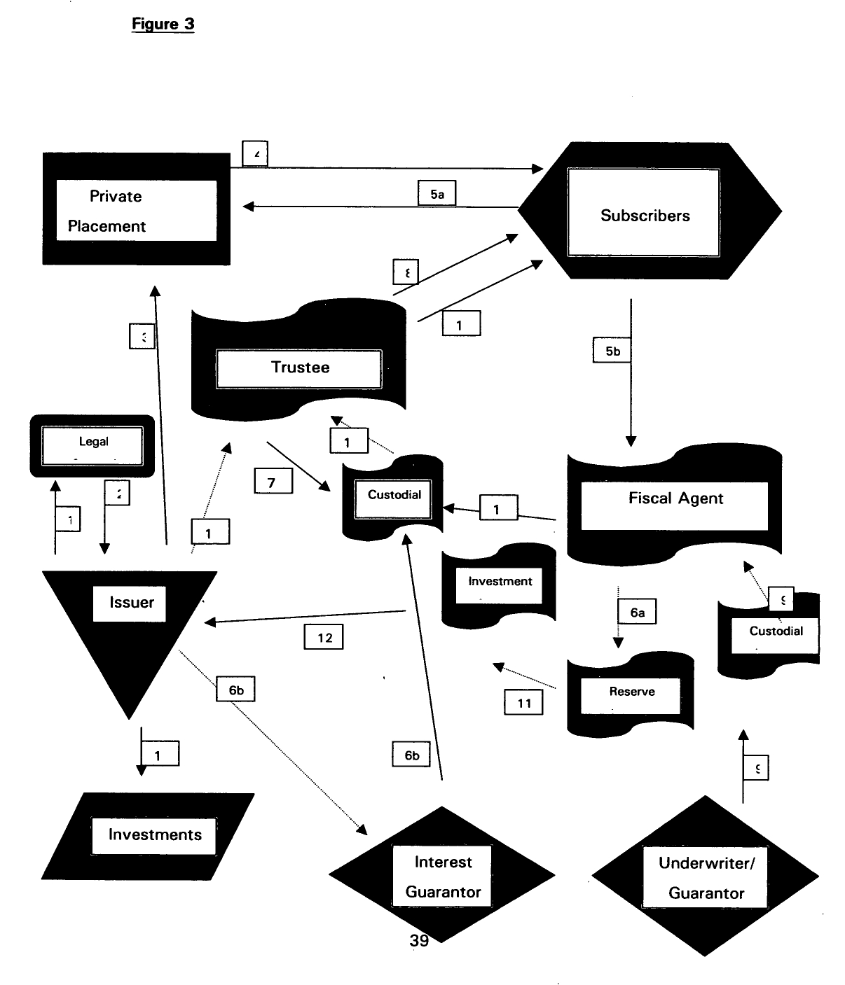

Referring to FIG. 3, a methodological schematic depicting a general overview of a subscription through interest payments process in accordance with the principles of the present invention is seen. A special purpose bankruptcy remote entity is created (“Issuer”) which issues the Notes and which is wholly owned by the beneficial project operator, investment fund or such other operating entity which is responsible for the implementation of the investment criteria. In addition to issuing the Notes, the Issuer makes the offering for the purpose of attracting investment, and subsequently enables the management and implementation of the proceeds arising from the sale of the Notes in a manner consistent with the investment criteria established related to that certain offering. The Issuer creates a document that provides the potential investor with a required description of and disclosure related to the nature of the Notes being offered for sale (“Offering Memorandum”). The Offering Memorandum and supporting documentation are provided (101) to counsel to the Issuer for review and the rendering of certain requisite legal opinions required to complete the offering package.

The Offering Memorandum and supporting documentation are tendered (103) by the Issuer to an agent (“Private Placement Agent”) for placement with qualified investors. The target market for the Notes consists of institutional investors (such as, for example, money market funds), corporations, trust departments and, to a lesser extent, high net worth individuals (collectively, the “Subscribers”). The Private Placement Agent is responsible for marketing the offering and preferably should have a close association with the institutional capital markets in the area of money market funds and other institutions which would fall under the Security and Exchange Commission Investment Company Act.

The Subscriber provides (105a) advice of its intended purchase of the Notes. Just prior to the time of sale of the Notes, (A) the Issuer shall (i) cause to be deposited with an acceptable institution an amount of funds sufficient to cover placement fees and any other costs associated with the issuance and offering of the Notes so that the fees may be made payable at closing while still permitting the Note proceeds to be deposited into the Reserve Account (defined below) and (ii) cause to be deposited with an acceptable institution funds or other acceptable collateral sufficient to cause the issuance of a letter of credit having a value sufficient to cover minimum interest payments due under the Notes upon issuance for a prescribed period of time and at a predetermined cap rate of interest; or (B) the Issuer provides sufficient alternative inducements to an acceptable institution to cause the issuance of one or more instruments or letter(s) of credit to cover (i) placement fees and any other costs associated with the issuance and offering of the Notes so that the fees may be made payable at closing while still permitting 100% of the Note proceeds to be deposited into the Reserve Account (defined below), and (ii) minimum interest payments due under the Notes upon issuance for a prescribed period of time and at a predetermined cap rate of interest. In the present example, the Subscriber acquires the Notes via electronic payment and book-entry delivery of the instruments (105b). In the present example, the payment for the Notes is tendered directly to a financial institution (“Fiscal Agent”). In the preferred embodiment, the Fiscal Agent is a banking institution of sufficient credit quality to meet minimal rating criteria set forth by the nominated credit rating agency which rates the Notes.

Proceeds from the sale or placement of the Notes (“Reserved Note Proceeds”) are placed on deposit in a dedicated and restricted reserve account (“Reserve Account”). Since the Reserved Note Proceeds are the property of the Issuer (a bankruptcy-remote special purpose entity), the bankruptcy or insolvency of its parent (the operating company investing the Note proceeds) will not prevent the Reserved Note Proceeds from being available to secure the Notes. The Reserved Note Proceeds—secure the principal portion of the Notes during an initial period of time (“Reserve Period”) immediately following Note issuance while the Notes are considered convertible (“Convertible Notes”). The Reserve Period continues until the date on which an aggregate value of letter(s) of credit (“Principal Letter of Credit”) is/are issued and delivered as required to secure the full principal portion of Notes then outstanding until the maturity date of the respective Notes. Although not illustrated in this example, the Issuer may elect to establish certain advantageous restrictions on conversion which may cause some Convertible Notes to not be converted prior to their maturity date, thus permitting the Reserve Period to continue throughout the full term of a given Note series. In practical terms, such a restriction on conversion causes some portion of the Convertible Notes in a series to remain in their cash-secured status, requiring an equal value of funds to be held on the reserve account throughout all or an extended part of their respective Note term. Upon the issuance and delivery of any Principal Letter of Credit, an equal value of the Convertible Notes equal to the face amount of such Principal Letter of Credit will convert into Notes which will be secured solely by the Principal Letter of Credit (“Converted Notes”). In the present example, upon issuance and delivery of any Principal Letter of Credit, the Convertible Notes will be subject to a mandatory tender to be purchased on a pro rata basis by the Issuer at par, plus accrued and unpaid interest, or as an alternative, otherwise substituted (pro rata) on a par basis for an equal value of Converted Notes, although a professional skilled in the art may elect to utilize another method of Note conversion.

An entity (“Trustee”) is designated as responsible for the administration of the Notes for the benefit of the Issuer and the Note Holders throughout the life of the Notes. The Fiscal Agent acts to administer the Reserved Note Proceeds on behalf of the Issuer and Trustee by the establishment, maintenance and management of the Reserve Account during the Reserve Period. The Reserve Account may be an interest-bearing account to be maintained at the Fiscal Agent's institution. Reserved Note Proceeds are restricted for withdrawal from the Reserve Account until after the delivery of one or more of the Principal Letter(s) of Credit which secure the Converted Notes.

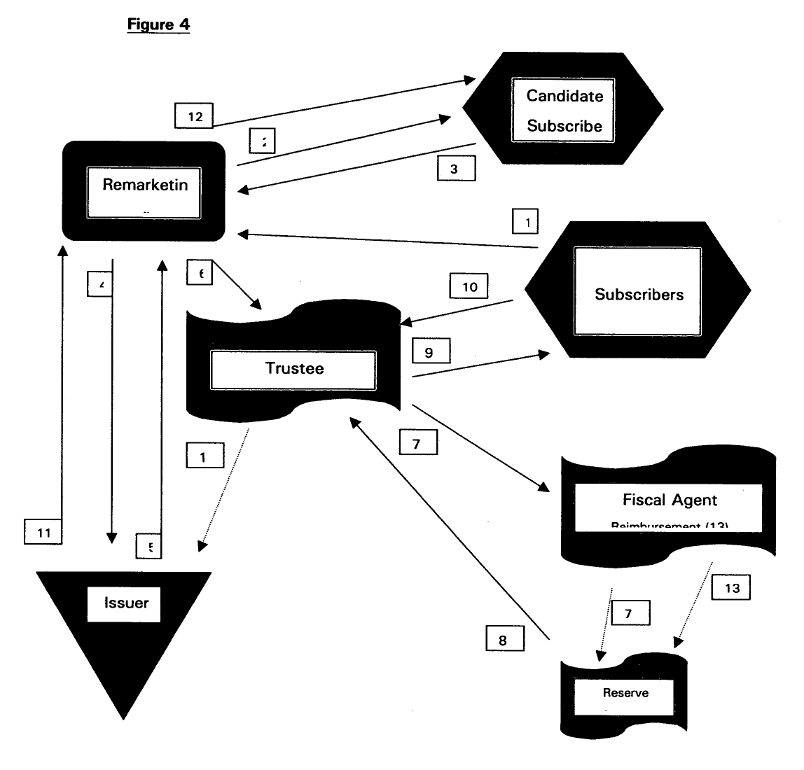

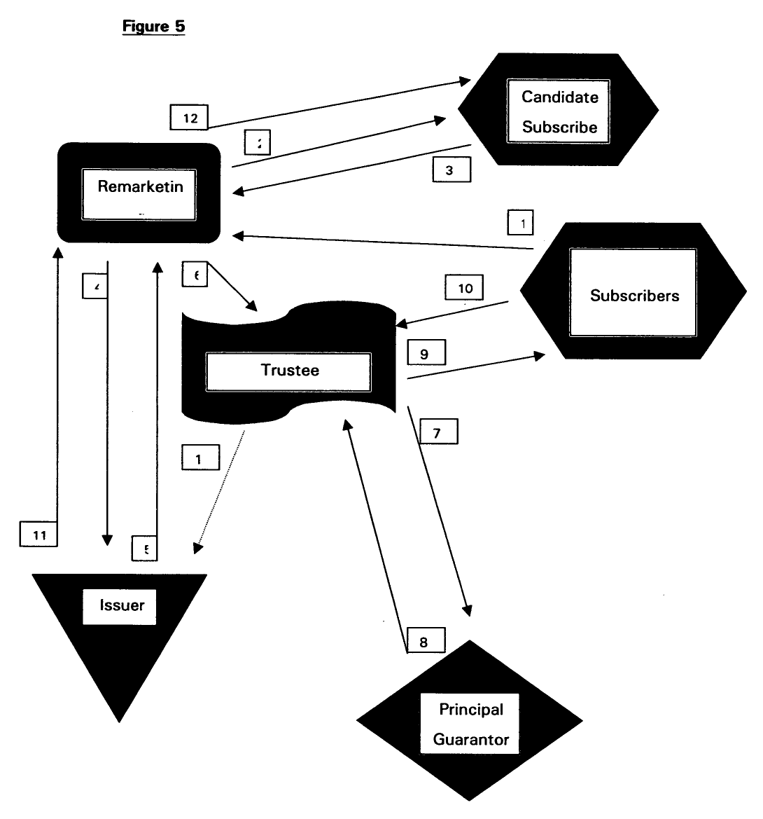

As referenced earlier, upon receipt of payment, the Fiscal Agent deposits (106a) Note proceeds to the Reserve Account. The Note proceeds serve as the basis to reserve the full value of proceeds to cover any required payment of the principal portion of the Convertible Notes upon a mandatory or optional tender of all or any portion of the Convertible Notes during the Reserve Period. An entity (“Remarketing Agent”) is engaged at the time of offering for the remarketing or resale of any tendered Notes during the life of the Notes. As described in more detail with reference to FIGS. 4 and 5, below, in the event of a mandatory or optional tender of the Notes, the Remarketing Agent remarkets the tendered Notes to additional or replacement subscribers. The remarketing of the tendered Notes maintains the long-term integrity of the financing/proceeds made available to the Issuer upon the initial placement of the Notes.

Concurrently, the Issuer causes the issuance and delivery (106b) of a letter of credit covering the agreed minimum interest on the Notes (“Interest Letter of Credit”). The Interest Letter of Credit is usually in the form of a “direct-pay” letter of credit, although a professional skilled in the art may elect to utilize another letter of credit form. The Interest Letter of Credit secures the payment of interest due under the Notes to the designated safekeeping account (“Custodial Account”) established at the Trustee's institution and is issued by an institution deemed acceptable by the Trustee pursuant to minimum credit requirements which meet the credit rating criteria as determined by the rating agency which rated the Notes (the “Interest Guarantor”). The Trustee accepts and holds the Interest Letter of Credit for the ultimate benefit of the Subscribers and covering scheduled payments of interest on behalf of the Subscribers.

Pursuant to the interest payment schedule agreed under the terms and conditions of the Notes, the Trustee draws (107) the required interest payments against the Interest Letter of Credit and subsequently disburses (108) the interest payments to the Subscribers. Although, in the present example, a Book-Entry Only System is utilized for settlements, a professional skilled in the art will recognize, in lieu of the Book-Entry Only System, physical Note certificates may be issued.

For the purposes of fiscally enhancing the Notes upon conversion and making Reserved Note Proceeds freely available for intended investment or application for the purposes disclosed in the Offering Memorandum, one or more financial entities are engaged for the issuance of a third party guarantee in the form of the Principal Letter of Credit (“Guarantor”) as security for the Converted Notes. The Guarantor may consist of a single banking institution, one or more banking institutions participating in a syndication, or one or more insurance companies or reinsurers organized in relation to a performance guarantee mechanism or insurance policy. However, in general there is a lead underwriting institution of sufficient credit quality to meet minimal rating criteria set forth by the nominated credit rating agency which subsequently rates the Converted Notes. In the preferred embodiment, the use of a lead banking institution of sufficient credit quality as Guarantor is believed to be the most efficient means of affecting the issuance of one or more of the Principal Letter(s) of Credit required for issuance upon Note conversion.

The Guarantor issues a guarantee in support of all or any portion of the principal portion of the Notes. The guarantee is issued as the basis of credit enhancement of the Converted Notes for the purposes of maintaining the investment grade rating thereof, even upon disbursement and use of the Reserved Note Proceeds by the Issuer after the Conversion Date. The credit rating of the lead banking institution as Guarantor generally serves as the basis to enhance the rating of the Converted Notes in order to meet the minimum rating criteria as defined by market-related conditions for the sale of the Notes. It is possible, however, that upon conversion of the Notes, the Converted Notes may not by re-rated to reflect the employment of the Principal Letter of Credit in place of all or any portion of the Reserved Note Proceeds, and thus a change in the nature of the underlying security for the Notes upon conversion may not change the rating of the Notes whether in their respective convertible or converted form, but may only cause an adjustment of Note pricing or interest rates payable on the Notes as dictated by the market.

Upon the identification and readying of the initial investments during the term of the Reserve Period, the Issuer causes instruction to be given to the Guarantor calling for the issuance and delivery (109) of one or more Principal Letter(s) of Credit to a safekeeping account established at the Fiscal Agent's institution. This safekeeping account is established for the purposes of accepting the Principal Letter(s) of Credit on behalf of the Trustee. The Principal Letter(s) of Credit, by the conclusion of the Reserve Period, have an aggregate total face value equal to the principal portion of Notes outstanding and issued, indicating that the conclusion of the Reserve Period is signaled by the conversion of Convertible Notes into Converted Notes, unless otherwise disclosed or defined in the Offering Memorandum. The receipt of acceptable Principal Letter(s) of Credit induces a mandatory tender of an equal value of Convertible Notes or, alternatively, a substitution of an equal value of Converted Notes for the Convertible Notes and permits the release, either incrementally or as a whole, of an equal value of Reserved Note Proceeds by the Fiscal Agent pursuant to the instruction of the Issuer. This completes the conversion from cash-backed Notes to letter of credit-backed Notes as applicable to all or certain of the Notes then outstanding.

As the basis to cause the issuance of the Principal Letter of Credit, certain collateral and security will be agreed with the Guarantor. The formulation of an acceptable credit structure is accomplished with a candidate Guarantor, among other means, by way of the negotiation and definition of: specific investment eligibility criteria that serves as the “blanket” investment policy applicable to the Notes and credit policy of the Guarantor related to the compilation of the investment portfolio; the establishment of an investment draw schedule during the life of the Notes that may require certain minimum cash values be maintained on certain designated or nominated accounts up to the date of scheduled final maturity; the allocation or reserve of a certain portion of Note proceeds in favor of the Guarantor; the allocation of a certain percentage of investment earnings, profits or yields arising from the investments during the term of the Notes into a dedicated reserve account to be held by the Guarantor; the granting of a security interest in certain accounts and assets in favor of the Guarantor; and/or the granting of a security interest in other additional collateral deemed acceptable to the Guarantor in support of the issuance of the Principal Letter of Credit.

Examples of specific investment eligibility criteria may be defined pursuant to specific formulas which identify minimum required asset ratios when compared to total investment in a subject project, specific minimum historical performance ratios for a given candidate investment or project, required percentage-based cash reserve requirements which may be deposited with and held by the Guarantor during the life of a subject investment, the creation of a sinking fund to directly offset and compensate the Guarantor for the maximum perceived potential loss of asset value during the life of a given investment, and/or the establishment of a specific asset to investment ratio.

The basis of negotiating and securing the Principal Letter of Credit may include any one or more of the aforementioned mechanisms or such other mechanism as a specific Guarantor may warrant and a specific Issuer may grant. In any event, in securing the Principal Letter of Credit the formulation of an investment criteria is established which sufficiently supports the valuation of the total available assets at Note maturity, inclusive of the investment portfolio itself and any cash reserves or earnings generated or arising from such cash reserves which may be scheduled or accrued during the term of the Notes. Thus, the Guarantor may issue its Principal Letter of Credit solely in support of the Trustee for the benefit of the owners of the Notes (“Note Holders”) which have been sold via the offering and is not being engaged for the purposes of guaranteeing specific performance of the Notes, but rather to secure the principal portion of the Converted Notes outstanding.

In the case of the Guarantor as a banking institution having an acceptable investment grade rating of its obligations, the credit rating of the obligations of the Guarantor will become the basis by which the creditworthiness of the Converted Notes are measured. In this example, the Principal Letter of Credit takes the form of a letter of credit, preferably a standby letter of credit, although a professional skilled in the art may elect to use another letter of credit form which becomes payable upon a call for payment by the Trustee that is prompted by the inability of the Issuer to meet a mandatory or optional tender of Converted Notes.

The foregoing generally identifies the specific performance obligation that is being supported by the Principal Letter of Credit and the considerations to be weighed in order to satisfactorily secure or otherwise collateralize and issue the Principal Letter of Credit. These principles may be readily applied to a varied selection of Underwriters/Guarantors from both the banking and insurance industries. The lead Guarantor, at its option, may defray its risk by syndicating its participation via the “selling off” of portions of the obligation represented by the Principal Letter of Credit to other banking or financial institutions.

Alternatively, the syndication process described above may be undertaken directly by the Issuer in the creation of a banking or insurance consortium for the issuance of multiple letters of credit which aggregate sum of their respective face values will total the par value of outstanding Notes prior to the close of the maximum allowable Reserve Period. Institutions participating in the consortium have a certain minimum investment grade rating of their respective obligations such that the credit rating agency may establish a blended rating for the Converted Notes, as necessary, which are ultimately supported by the Principal Letter of Credit to be issued by the consortium. Although potentially open to interpretation, the operation of individual Principal Letter(s) of Credit concurrently assures certain parity between or equality among the outstanding Converted Notes.

Upon receipt of the Principal Letter of Credit which induces the mandatory tender of the Convertible Notes for purchase by the Issuer, or, alternatively a substitution of Converted Notes for Convertible Notes of equal value, the Fiscal Agent documents the face value thereof, allocating an equal value of Reserved Note Proceeds for disbursement there against, and transfers (110) the entirety of the Principal Letter of Credit to the Trustee, naming the Trustee as the second beneficiary thereof. Although not illustrated, alternatively, the Principal Letter of Credit may be delivered directly in favor of the Trustee, bypassing the Fiscal Agent. Once issued and delivered in its favor, the Trustee as may be required may thereafter affect draws under the Principal Letter of Credit directly related to the Converted Notes, without any further referral to the Fiscal Agent.

Against the transfer and/or delivery of the Principal Letter of Credit and the corresponding conversion of the Convertible Notes correspondent thereto, an equal value of Reserved Note Proceeds is then available for subsequent withdrawal from the Reserve Account and investment upon the Issuer's instruction to the Fiscal Agent. As the means of administering investment draws by the Issuer, the Fiscal Agent creates an interest-bearing, depository account at the Fiscal Agent's institution (“Investment Account”) designated for the deposit and disbursement of Note proceeds in favor of a certain identified investment. The Fiscal Agent deposits (111) available Note proceeds into the Investment Account pending further disbursement instruction from Issuer. Deposits into the Investment Account permit the timely and documented withdrawals of proceeds in support of the commencement of the scheduled investments, thus assuring that the Guarantor may audit as needed, the disbursements of Note proceeds in favor of certain subject investments which meet the investment eligibility criteria as agreed between the Guarantor and the Issuer.

By way of example and not limitation, scheduled investments may include any approved, investment operation or project which does not contradict the Issuer's agreement with the Guarantor, including, but not limited to energy markets, equipment leasing, real estate, construction, manufacturing, entertainment and any other commercial activity deemed acceptable to the Issuer and the Guarantor. The Issuer (by instruction to the Fiscal Agent) draws (112) upon Note proceeds deposited to the Investment Account from the Reserve Account for direct and specific application by the parent of the Issuer to certain scheduled investments that constitute a portion of the Investment Portfolio. The scheduled investments are effected (113) in accordance with the investment eligibility requirements set forth in the Offering Memorandum.

At the Maturity Date, in the event of a mandatory or optional tender or upon advice to the Trustee of the intention of the Issuer to prepay the outstanding Notes, the Trustee either (i) collects (114) the principal portion of the Notes due from the Issuer directly, (ii) causes a draw against any remaining Reserved Note Proceeds to cover the outstanding principal portion of the Convertible Notes then outstanding, or (iii) causes (114) a draw under one or more of the Principal Letters of Credit to cover the outstanding principal portion of the Converted Notes then outstanding. The Trustee subsequently and timely disburses (115) an amount of funds sufficient to retire the principal portion of the Notes due concurrent with the disbursement of any final interest payments due as drawn under the Interest Letter of Credit. The Notes are thereafter fully paid and cancelled.

Referring now to FIG. 4, a methodological schematic showing details of settlement of a permitted tender of the Convertible Notes during the Reserve Period in accordance with the principles of the present invention is seen. In the present example, an optional tender is sited in which one or more of the existing Subscribers give notice of tender of Notes as permitted pursuant to an agreement (“Indenture”). The Indenture is entered by the Issuer and the Trustee and governs the administration of the Notes. The Fiscal Agent is an administrative extension of the Indenture.

Such notice of tender of Notes during the Reserve Period causes the Remarketing Agent to (201) attempt to resell the tendered Convertible Notes prior to any draw upon Reserved Note Proceeds by the Trustee. If the Remarketing Agent is unsuccessful in reselling the Convertible Notes (202) to other third party alternative candidate subscribers (“Candidate Subscribers”), the Issuer is required to repurchase the Convertible Notes upon tender from the Subscribers. For the purposes of the present discussion, it has been assumed that the Remarketing Agent was unsuccessful in reselling the Convertible Notes and the Candidate Subscribers refused (203) the purchase. Upon the failure of the Remarketing Agent to timely place the tendered Convertible Notes, the Issuer is contacted (204) to repurchase the Convertible Notes being tendered. Again, for the purposes of the present discussion, the Issuer is assumed to not be able to satisfy the tender (205).

The Trustee is notified (206) of the unavailability of funds sufficient to satisfy the pending tender, and the Trustee calls upon the Fiscal Agent (207) for disbursement of the required funds from the Reserved Note Proceeds as held as security for the tendered Convertible Notes within the Reserve Account. The Trustee only calls for funds sufficient to satisfy the pending tender; however, the Trustee may call for an amount up to the full value of outstanding Convertible Notes as directly covered for payment by the full value of Reserved Note Proceeds as held by the Fiscal Agent.

The Fiscal Agent transfers (208) to the Trustee the funds from the Reserve Account called for by the Trustee. The Trustee disburses (209) required payment to the Subscriber in settlement, and the Subscriber surrenders (210) the Convertible Notes being tendered to the Trustee for the benefit of the Issuer. The Issuer subsequently instructs (211) the Remarketing Agent to continue to remarket the Convertible Notes that have been tendered such that the full value of Reserved Note Proceeds may be restored. It may be reasonably assumed that the Convertible Notes shall be successfully remarketed (212) by the Remarketing Agent to suitable Candidate Subscribers. Proceeds from the resale of the Convertible Notes are deposited (213) with the Fiscal Agent in the Reserve Account such that Convertible Notes then outstanding are properly covered by the aggregate total of Reserved Note Proceeds held by the Fiscal Agent.

Referring now to FIG. 5, a methodological schematic showing details of settlement of a permitted tender of the Converted Notes in accordance with the principles of the present invention is seen. Like the foregoing example in FIG. 4, an optional tender is sited in which one or more of the existing Subscribers give notice of tender of Converted Notes is permitted pursuant to the Indenture. The tender of Converted Notes as permitted pursuant to the Indenture, whether such tender occurs while the Reserve Period is still in effect or not. The tender of Converted Notes causes the Remarketing Agent to attempt to (301) resell the Converted Notes being tendered.

If the Remarketing Agent is unsuccessful in reselling the Converted Notes (302) to other Candidate Subscribers, the Issuer is required to repurchase the Converted Notes upon tender from the Subscribers. For the purposes of the present discussion, it has been assumed that the Remarketing Agent was unsuccessful in reselling the Converted Notes and the Candidate Subscribers refused (303) the purchase. Upon the failure of the Remarketing Agent to timely place the tendered Converted Notes, the Issuer will be contacted (304) to repurchase the Converted Notes being tendered. Again, for the purposes of the present discussion, the Issuer (305) is assumed to not be able to satisfy the tender.

The Trustee is notified (306) of the unavailability of funds sufficient to satisfy the pending tender. Given that the present FIG. 5 applies expressly to Converted Note tenders, the Trustee at the time of tender is holding in its designated custodial account, one or more Principal Letter(s) of Credit which secure the principal portion of the outstanding Converted Notes and names the Trustee as the Beneficiary thereof for the benefit of the Note Holders. Pursuant to the terms of the Principal Letters-of-Credit, the Trustee draws upon the Principal Letter(s) of Credit (307) (pro rata if applicable) for the full value of funds due for payment to the Note Holders/Subscribers upon the effective Converted Note tender (less any amount available from the Issuer, if any). The Trustee only draws funds sufficient to satisfy the pending tender; however, the Trustee may call for an amount up to the full value of outstanding Converted Notes as directly covered for payment by Principal Letter(s) of Credit then issued and operative.

The entity that issues the Principal Letter of Credit applicable to a given Converted Note then being tendered (also known as the Guarantor) pays (308) the Trustee's draw under the Principal Letter of Credit pursuant to the terms of the Principal Letter of Credit and disburses per the instruction of the Trustee. The Trustee disburses (309) the required payment to the Subscriber in settlement, and the Subscriber surrenders (310) the Converted Notes being tendered to the Trustee for the benefit of the Issuer. The Issuer or Guarantor, as the case may be based upon the nature of the credit agreement between the Issuer and Guarantor, subsequently instructs (311) the Remarketing Agent to continue to remarket the Converted Notes which have been tendered such that the payments made to the Trustee under the terms of the Principal Letter of Credit may be reimbursed or the amounts available for draw under the Principal Letter of Credit otherwise restored. It may be reasonably assumed that the Converted Notes are successfully remarketed (312) by the Remarketing Agent to suitable Candidate Subscribers. Proceeds from the resale of the Converted Notes are applied as agreed or required by the Guarantor and Issuer.

While the invention has been described with specific embodiments, other alternatives, modifications and variations will be apparent to those skilled in the art. For example, depending on the particular needs of an investment a financial instrument in accordance with the present investment can be combined with other financial instruments in a single offering. Accordingly, it will be intended to include all such alternatives, modifications and variations set forth within the spirit and scope of the appended claims.

The following Glossary of Terms is set forth for convenience and should not be construed as limiting the scope of the present invention:

Glossary of Terms:

Candidate Subscribers: other third party alternative subscribers to whom the Remarketing Agent offers to resell the Notes following a permitted tender of the Notes by an existing Subscriber during the Reserve Period.

Collateralized Variable Rate Demand Note (CVRDN): an example of a financial instrument in accordance with the principles of the present invention.

Converted Note: a form of Note which principal is secured solely by one or more Principal Letter(s) of Credit.

Convertible Note: a form of Note which principal is secured solely by cash held on the Reserve Account.

Custodial Account: the safekeeping account established at the Trustee's institution for the purposes of accepting and holding the Letter(s) of Credit for the ultimate benefit of the Subscribers.

Fiscal Agent: a banking institution having a credit agency rating of its long-term obligations of sufficient quality to meet minimal rating criteria set forth by the nominated credit rating agency which rates the Notes; acts as the administrator and interim manager for Reserved Note Proceeds under certain guidelines and paying agent on behalf of the Issuer related to its scheduled investments.

Guarantor: This entity may consist of several international banking institutions, insurers or functionally comparable entities; however, in general there is a lead underwriting institution of sufficient credit quality (its credit rating according to S&P or Moody's) to meet minimal rating criteria set forth by the nominated credit rating agency which subsequently rates the Notes. The Guarantor is engaged for the purposes of issuance of its guarantee in support of the principal portion of the Notes.

Indenture: the agreement entered by and between the Issuer and the Trustee which governs the administration of the Notes and to which the Fiscal Agent is an administrative extension.

Guarantor: the issuer of the Interest Letter of Credit.

Interest Letter of Credit: the letter of credit that secures the payment of interest due under the Notes; usually issued as a direct-pay letter of credit.

Investment Account: an interest-bearing, depository account at the Fiscal Agent's institution designated for the deposit and disbursement of Note proceeds in favor of certain identified investments.

Issuer: a bankruptcy remote special purpose entity which issues the Notes, makes the offering for the purpose of attracting investment and subsequently manages and implements the proceeds of the sale of the Notes prior to the application of the proceeds in a manner consistent with the investment criteria established upon Note issuance and as stated in that certain Offering Memorandum.

Note: the financial instrument being offered for sale to the institutional capital markets in accordance with the principles of the present invention.

Note Holders: the subscribers; the owners of the Notes which have been sold via the offering.

Offering Memorandum: the document which provides the potential investor with a required description of and disclosure related to the nature of the Notes being offered for sale.

Principal Letter(s) of Credit: the Letter(s) of Credit which secure the payment of the principal portion of the Converted Notes.

Private Placement Agent: the entity which is expressly responsible for the marketing of the offering on behalf of the Issuer.

Remarketing Agent: the entity that is engaged at the time of offering of any alternative entity substituted therefore at any time subsequent thereto for the remarketing or resale of any tendered Notes during the life of the Notes.

Reserve Account: an interest bearing, depository account at the Fiscal Agent's or Guarantor's institution designated for the reservation and holding of funds as security for the Convertible Notes during the Reserve Period, but, however, prior to the Conversion Date of the Convertible Notes.

Reserved Note Proceeds: those Note proceeds which are placed on deposit in the Reserve Account for the purpose of cash-securing the principal portion of the Convertible Notes during the Reserve Period but, however, prior to the Conversion Date of the Convertible Notes.

Reserve Period: that period of time while Note proceeds are held in the Reserve Account.

Subscribers: those entities, parties or individuals who purchase the Notes, consisting primarily of institutional investors (such as for example money market funds), corporations, trust departments and, to a lesser extent, high net worth individuals.

Trustee: the entity responsible for the administration of the Notes for the benefit of the Issuer and the Note Holders throughout the life of the Notes; governed by the terms and conditions of the Indenture executed with the Issuer.

Variable Rate Demand Notes (VRDNs): short-term floating rate debt instruments that may be credit enhanced by application of a bank letter of credit or a municipal bond insurance policy.

What is claimed is:

1. A computer automated monitoring and reporting system for a financial instrument comprising:
calculating and tracking the operating and issuance activities of each user of the present invention; and
compiling reference data as to collective market deployment pertaining to the use of the financial instrument.

2. The computer automated monitoring and reporting process of a financial instrument of claim 1 further including passing information through a secure web connection.

3. The computer automated monitoring and reporting process of a financial instrument of claim 1 further including receiving the information in a standardized web-based form.

4. The computer automated monitoring and reporting process of a financial instrument of claim 1 further including preparing periodic reports on user information.

5. A computer automated monitoring and reporting of a financial instrument comprising:
calculating and tracking the financial standing of each investment arising from the proceeds of an offering of investment units; and
compiling reference data as to consolidated investment status and financial standing of proceeds arising from the use of the financial instrument.

6. The computer automated monitoring and reporting process of a financial instrument of claim 5 further including passing information through a secure web connection.

7. The computer automated monitoring and reporting process of a financial instrument of claim 5 further including receiving the information in a standardized web-based form.

8. The computer automated monitoring and reporting process of a financial instrument of claim 5 further including preparing periodic reports on investment performance information,
financial instrument for the purposes of maintaining an investment grade rating of the financial instrument, even upon use of the proceeds in an investment.

9. A computer supported method of financing comprising:
offering a financial instrument for the purpose of attracting investment;
placing the proceeds from the financial instrument on deposit in an account in such manner so as to ensure the bankruptcy remote status of such proceeds from an entity offering the financial instrument;
subsequently issuing a letter of credit to secure the payment of a principal portion of the financial instrument; and
managing and implementing the proceeds of the sale of the financial instrument in a manner consistent with a generic investment criteria established related to that certain offering.

10. The method of financing of claim 9 further including initially rating the financial instrument by a credit rating agency based upon structures employed during an initial reserve period for the financial instrument and subsequently rating the financial instrument by a credit rating agency based upon the letter of credit-based credit enhancement mechanisms.

11. The method of financing of claim 9 further including the reserved proceeds having a value equal to the principal portion of convertible financial instruments then outstanding.

12. The method of financing of claim 9 further including the letter of credit having a value equal to the principal portion of converted financial instruments.

13. The method of financing of claim 9 further including restricting the withdrawal of proceeds until after the delivery of the letter of credit.

14. The method of financing of claim 9 further including, against delivery of the letter of credit, making available an equal value of proceeds for investment.

15. The method of financing of claim 9 further including the generic investment eligibility criteria serving as an investment guideline.

16. The method of financing of claim 9 further including the generic investment eligibility criteria serving as a credit guideline.

17. The method of financing of claim 9 further including the generic investment eligibility being a formula which identifies an asset ratio.

18. The method of financing of claim 9 further including the generic investment eligibility criteria being a performance ratio.

19. The method of financing of claim 9 further including the generic investment eligibility criteria being a percentage-based cash reserve guideline.

20. The method of financing of claim 9 further including the generic investment eligibility criteria being a sinking fund to compensate for loss.

21. The method of financing of claim 9 further including the generic investment eligibility criteria being an asset ratio.

22. The method of financing of claim 9 further including, in the event of a tender, collecting the principal portion of the financial instruments due.

23. The method of financing of claim 141 further including, in the event of a tender of convertible notes, drawing upon the reserved proceeds to cover the outstanding principal portion of the financial instruments being tendered.

24. The method of financing of claim 141 further including, in the event of a tender of converted notes, drawing under the letter of credit to cover the outstanding principal portion of the financial instruments then being tendered.

25. The method of financing of claim 9 further including, upon advice of an intention to prepay outstanding financial instruments, collecting the principal portion of the financial instruments being prepaid.

26. The method of financing of claim 9 further including the account being a reserve account.
